(19) United States
(12) Patent Application Publication
(10) Pub. No.: US 2024/0103124 A1
(43) Pub. Date: Mar. 28, 2024

(54) POLARIZATION-EXPLOITING RADAR ARCHITECTURES

(71) Applicant: Apple Inc., Cupertino, CA (US)

(72) Inventors: Matthew A. Mow, Los Altos, CA (US); Jiaming Cui, Milpitas, CA (US); Fanfan He, Cupertino, CA (US); Joseph Hakim, Jacksonville, OR (US)

(73) Assignee: Apple Inc., Cupertino, CA (US)

(21) Appl. No.: 18/467,473

(22) Filed: Sep. 14, 2023

Related U.S. Application Data
(60) Provisional application No. 63/409,159, filed on Sep. 22, 2022.

(51) Int. Cl. G01S 7/02; G01S 7/40; G01S 13/56; G01S 13/75

(52) U.S. Cl. CPC G01S 7/024; G01S 7/4004; G01S 13/56; G01S 13/755

(57) ABSTRACT

Techniques are disclosed for cross-polarization-based object detection and classification. One example includes a system implemented for cross-polarization-based object detection and classification. The system includes a first transmitter antenna configured for radiating a first millimeter wave electromagnetic signal, where the first millimeter wave electromagnetic signal including a first polarization. The system further includes a first receiver antenna configured for receiving a second millimeter wave electromagnetic signal, the second millimeter wave electromagnetic signal including a second polarization. The system further includes a processing circuitry configured to detect an object based at least in part on the second millimeter wave electromagnetic signal, the object being impacted by the first millimeter wave electromagnetic signal to cause the second millimeter wave electromagnetic signal to reflect off the object.

### CROSS-REFERENCE TO RELATED APPLICATIONS

This application is claims priority under 35 U.S.C. § 119(e) to U.S. Provisional Application No. 63/409,159, filed on Sep. 22, 2022, the contents of which is incorporated by reference.

### BACKGROUND

Wireless sensing can be the process of detecting and monitoring characteristics of objects in an area through the measurement of signals transmitted and then received by a wireless sensor. One form of wireless sensing is radar-based object detection and classification and can include using transmitted and reflected radio transmissions to detect and classify objects.

### BRIEF DESCRIPTION OF THE DRAWINGS

FIG. 1 is an illustration of a polarization-exploiting radar architecture, according to one or more embodiments.

FIG. 2 is an illustration of a polarization-exploiting radar architecture and a reflector, according to one or more embodiments.

FIG. 3 is an example of non-polarization-exploiting radar architecture, according to one or more embodiments.

FIG. 4 is an example of a polarization-exploiting radar system, including a polarization-exploiting radar architecture, a clutter object, and a reflector, according to one or more embodiments.

FIG. 5 is an illustration of a dual-polarization receive radar architecture with a switch, according to one or more embodiments.

FIG. 6 is an illustration of a switchless dual-polarization receive radar architecture with a switch, according to one or more embodiments.

FIG. 7 is an illustration of a dual-polarization transmit and receive radar architecture with switches, according to one or more embodiments.

FIG. 8 is an illustration of a dual-polarization transmit and receive radar architecture with switches, according to one or more embodiments.

FIG. 9 is an illustration of a dual-polarization transmit and receive radar architecture with switches, according to one or more embodiments.

FIG. 10 is an illustration of a dual-polarization transmit and receive radar architecture with transmit and receive antennas that include polarization mode switching, according to one or more embodiments.

FIG. 11 is a process flow for object detection via polarization-exploitation, according to one or more embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. In order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

A radar system can be a collection of elements that are combined to transmit and receive radiating electromagnetic waves to characterize an object. The basic operating principle for a radar system includes having a transmitter radiate a radar signal toward an object via an antenna. The radar system can also include a receiver that can collect a reflected signal from the object using an antenna. The radar system can characterize the object based on the characteristics of the reflected signal. Radar-based detection and classification applications continue to be implemented as more and more consumer devices are equipped with sensors for characterizing a device's surroundings. The embodiments described herein are directed toward radar-based remote sensing via the measurement of polarized millimeter waves. General descriptions of concepts related to radar-based remote sensing are provided below.

A radar system can be configured to transmit and receive polarized signals, in which polarization describes the orientation of an electric field component of the signal. The electric field component can oscillate in any direction normal to the direction that the radar system propagates the signals. The polarized signals can have a fixed, constant orientation and can create a path across a flat plane in time and space. Therefore, the electric field can oscillate in any direction that lies in the flat plane. A signal whose electric field component oscillates in this manner can be considered linearly polarized. Two common forms of linear polarization include vertical polarization, in which the flat plane can be orthogonal to a surface plane, and horizontal polarization, in which the flat plane can be parallel to the surface plane. Additional forms of polarization, such as circular polarization, slant (linear) polarization, and elliptical polarization, can also be used for remote sensing applications.

Although signals that are generated in nature generally oscillate in multiple directions, radar systems can, on the other hand, be configured to generate polarized signals. In general, a radar system can generate a polarized signal by using an antenna whose shape, materials, and orientation have been configured to generate polarized signals. Examples of this antenna include whips, dipoles, waves guide, and log-periodic (LP) antenna.

Cross-polarization refers to an instance where the radar's transmit polarization state can be orthogonal to the receive polarization state. For example, the transmit polarization state can be a vertical polarization, and the receive polarization state can have a horizontal polarization, or vice versa. Dual polarization refers to an instance in which the radar can transmit and receive in orthogonal polarization states. For example, the transmit polarization state can be a vertical polarization or horizontal polarization, and the receive polarization state can be a vertical polarization or horizontal polarization.

A radar system can further be configured to emit polarized signals in the millimeter band, which can be a band of spectrum that includes wavelengths in the millimeter range (e.g., 12.5 millimeters (24 GHz) to one millimeter (300 GHz)). The millimeter band can be advantageous in telecommunications as it enables higher data rates than at lower frequencies. This can make millimeter waves advantageous for data-heavy applications, such as telemedicine, home automation, virtual reality games, and augmented reality.

Embodiments herein are directed toward radar architectures that exploit polarization for the detection and classification of objects. The embodiments relate to a transmitter of a radar system operable to emit a stimulus signal in the millimeter range that includes a target set of characteristics, including a polarization. A receiver antenna of the radar system can collect a reflected signal from objects in an environment. Each object in the environment can have different physical and material characteristics, and therefore, a respective reflective signal from each object can include different characteristics, including polarization. The radar system can further detect and classify each object in the environment based on the characteristics of the stimulation signal in relation to the respective characteristics of the reflected signal from each object. This can include a millimeter wave spectroscopy enabling the classification of materials based on the characteristics of their reflection polarization response to a stimulus of specific polarization. These embodiments can be useful in environments in which a target object(s) inherently can reflect a signal having a different polarization than the stimulus signal.

In other embodiments, the radar system can employ a cross-polarization (Xp) reflector associated with a target object. The Xp reflector can be configured to be impacted by a transmitted signal having a polarization component and reflect a signal having a polarization component different than the transmitted signal. For example, if the radar system transmits a stimulation signal having a strong vertical polarization component, the Xp reflector can be configured to reflect a signal having a strong horizontal polarization component. This can assist in identifying a target object in instances that the surrounding objects in the environment have strong co-polar reflection (e.g., same polarization as stimulation signal) and the signal reflected off the Xp reflector will have a different set of characteristics (e.g., horizontal polarization). These embodiments can be useful in environments in which a target object(s) either do not inherently reflect a signal having a different polarization than the stimulus signal, or a radar architecture may require a stronger signal to detect the orthogonal polarization component.

The following embodiments include different radar architectures for implementing the functionality described herein. It should be appreciated that object detection and classification via polarization-exploiting radar architectures can be performed through various architectures, and not just cross-polarization architectures. The architectures described herein should not be considered an exhaustive list. Furthermore, it will be apparent to a person having ordinary skill in the art and having the benefit of the present disclosure that the various aspects of the various architectures may be practiced in other examples that depart from these specific details.

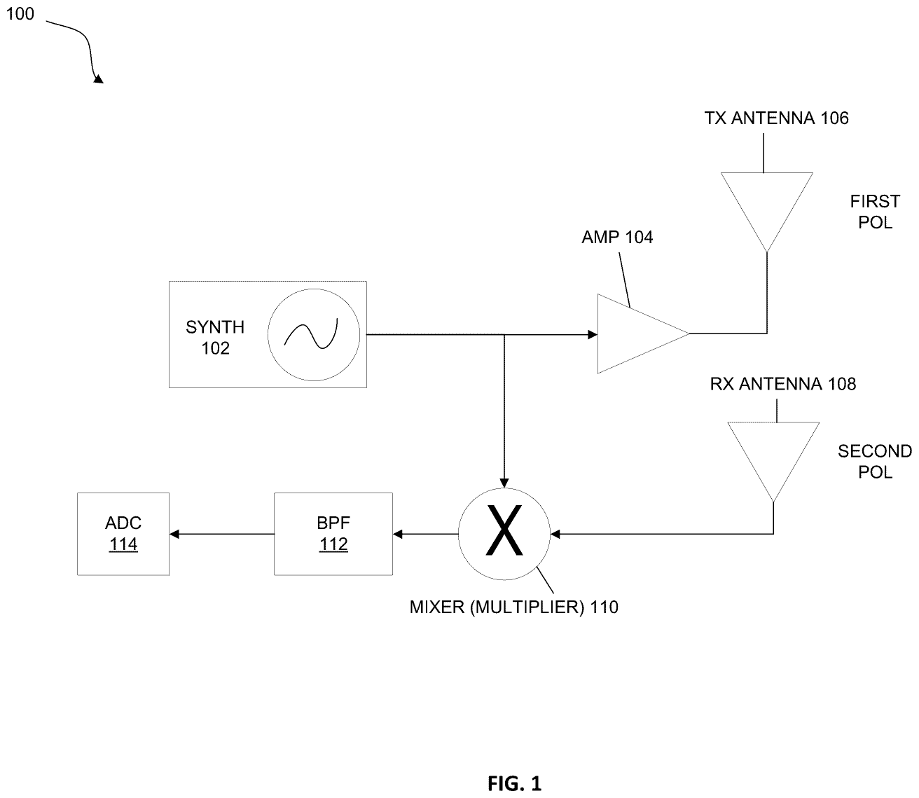

FIG. 1 is an illustration of a polarization radar architecture 100, according to one or more embodiments. The polarization radar architecture 100 can exploit cross-polarization for improved radar system performance (e.g., detection and classification of targets). The polarization radar architecture 100 can improve detection in environments with challenging levels of clutter by improving the signal-to-clutter ratio and can be implemented in various devices to suit various applications. For example, the polarization radar architecture 100 can be implemented in a computing device, such as a smartphone, tablet, or wearable device. In other instances, the polarization radar architecture 100 can be implemented in more substantial equipment, such as industrial machinery or stationary structures.

The polarization radar architecture 100 can include a synthesizer 102 (e.g., waveform generator) for generating an electrical waveform of a wide range of signal types. For example, the synthesizer 102 can be configured to generate a signal in the millimeter frequency range. The generated signal can be transmitted across a transmission line and received by an amplifier (amp) 104 (e.g., radio frequency amplifier), which can be an integrated circuit for amplifying the signal. In particular, the amplifier 104 can be a differential amplifier with a high differential mode gain, high input impedance, and low output impedance to enable the high gain. The amplified signal can be transmitted from the amplifier 104 to a transmitter antenna 106.

The transmitter antenna 106 can be configured to receive the amplified signal and transmit a polarized signal (e.g., stimulation signal). The polarization of the transmitter antenna 106 can be understood as the polarization of the electromagnetic fields that are produced by the antenna as energy radiates from the antenna. The transmitter antenna 106 can be configured to transmit a signal having a first polarization. For example, the first polarization can be a vertical polarization. The polarized signal can include characteristics (e.g., phase, amplitude, polarization state) that can be configured based on a target object or environment. In other words, each target object or environment can be associated with a respective set of stimulation characteristics. Take, for instance, two objects in an environment, where one of the objects can be a target object. The transmitter antenna 106 can transmit a signal that includes a set of stimulation characteristics for the target object. Each object can reflect a signal back to the polarization radar architecture 100. However, based on the stimulation characteristics, the target object can reflect a signal that has a set of characteristics identifiable with the target object. Additionally, the non-target object can reflect a signal that has a set of characteristics that are not identifiable with the target object.

It should be appreciated that the polarization-exploiting radar architecture antennas are not limited to vertical polarization and horizontal polarization. Furthermore, it should be appreciated that the various radar architectures are described with respect to vertical and horizontal polarization for illustrative purposes and other forms are applicable. As described above, another form of polarization can be circular polarization, in which the electrical field rotates as the signal propagates in time and space. If the signal rotates to the following right hand, the polarization can be referred to as right hand circular polarization (RHCP). If the signal rotates following the left hand, the polarization can be referred to as left hand circular polarization (LHCP). Therefore, if the transmitter antenna 106 was configured to transmit a signal with a RHCP, the receiver antenna can be configured to receive a signal with a LHCP to effectuate cross-polarization, or vice versa. Other forms of polarization can include slant polarization, in which the electrical field is orientated 45-degree relative to a reference plane. Of course, slant polarization is one version of linear polarization which can have an arbitrary polarization angle relative to a reference plane. Yet another form of polarization can be elliptical polarization, in which the signal propagates in an elliptical helix pattern.

The transmitter antenna 106 can be configured to transmit a signal having a target polarization with target characteristics (e.g., stimulation characteristics). The signal transmitted by the transmitter antenna 106 can be considered a configurable stimulation signal for stimulating an identifiable reflection signal off of a target object. The signal can be configured based on various parameters, such as target object material composition and target object shape.

The signal can be directed at an environment having a target object to be classified by a computing device, where the target object can be a stationary object or a moving object. As indicated above, the polarization radar architecture 100 can be implemented in various devices that can be, at times, stationary or moving. Therefore, there can be multiple scenarios in which the polarization radar architecture 100 can account for a transmitted signal in addition to accounting for target object characteristics and environment characteristics. One situation can be a stationary polarization radar architecture 100 and a stationary target object. Another situation can be a stationary polarization radar architecture 100 and a moving target object. Yet another situation can be a moving polarization radar architecture 100 and a stationary target object. Yet even another situation can be a moving polarization radar architecture 100 and a moving target object.

A receiver antenna 108 can be configured to receive a signal having a target polarization (e.g., vertical, horizontal, circular, elliptical, slanted). For example, the receiver antenna 108 can be configured to receive a signal having a horizontal polarization. The received signal can include characteristics (e.g., phase, magnitude, target reflectance, polarization state) to be used to detect and classify an object in an environment. The classification can include an object material, an object shape, a distance between the polarization radar architecture 100 and the object. The receiver antenna 108 can be configured to receive a polarized signal by, for example, configuring a physical structure of the antenna, configuring an orientation of the antenna, configuring materials used to fabricate the antenna, and configuring a mounting of the antenna.

The receiver antenna 108 can transmit the received signal to a mixer 110 (e.g., multiplier), which can be configured to also receive the original signal from the synthesizer 102 and the receiver antenna 108. The mixer 110 can modulate or demodulate a received signal to convert the signal frequency to a target frequency (e.g., intermediate frequency) without losing the signal characteristics. The mixer 110 can transmit the signal to a bandpass filter (BPF) 112. The BPF 112 can be used to limit the bandwidth of the output signal. For example, the BPF 112 can limit the bandwidth that passes through the bandpass filter 112 to reduce noise/interference, included in the signal received from the mixer 110. The BPF 112 can transmit the filtered signal to an analog-to-digital converter (ADC) 114. The ADC 114 can convert the analog signal received from the BPF 112 into a digital signal.

The ADC 114 can transmit the digital signal to one or more processing units to classify the objects. The processing unit can include a controller for controlling the characteristics of the transmitted signal and a classifier unit for detecting and classifying objects in an environment. The controller can be configured to transmit control instructions to the synthesizer to generate a signal to have certain characteristics. The signal characteristics can be selected such that the signal transmitted by the transmitter antenna 106 can be a polarized signal having characteristics conducive for object classification. The signal can include a first set of polarization characteristics (e.g., phase, magnitude, and polarization state). The characteristics can be target characteristics that the controller uses to generate the control instructions and be based on various parameters (e.g., environment, target object). The transmitter antenna 106 can transmit a polarized signal that impinges upon objects in an environment. The signal can reflect back towards the polarization radar architecture 100 where they are collected by the receiver antenna 108. The reflected signal can include a second set of polarization characteristics (e.g., phase, magnitude, and polarization state).

The classifier unit of the one or more processing units can measure the characteristics of the reflected signal and characterize the object in the environment. The classifier unit can determine a relative distance and/or position of objects in relation to the radar. For example, the classifier unit can determine a distance between the transmitted signal and the received reflected signal using time of flight (ToF) and radar signal processing. In instances where the polarization radar architecture 100 includes multiple antennas, the classifier unit can determine a relative position of the object based on the time of flight calculated and reflection angle at each antenna.

The classifier unit can further determine the characteristics of the target object and/or surrounding objects based on the signal characteristics of a signal reflected from each object. In an environment, each object can have a unique set of reflection signal characteristics (e.g., phase, amplitude, polarization characteristics). In other words, different materials can cause the reflected signal to have different characteristics. Based on determining the reflection signal characteristics, the classifier unit can identify a material that forms the object. For example, the classifier unit can compare the determined set of reflected signal characteristics to a table to identify a material. In some instances, the classifier unit can further make a determination as to an object class based on the position and material. For example, if the classifier unit detects a moving cloth material having a shape of a torso, the classifier unit can determine that the object can be a person walking.

It should be appreciated that although FIG. 1 shows that the polarization radar architecture 100 includes a single synthesizer 102, a single amplifier 104, a single transmitter antenna 106, a single receiver antenna 108, a single mixer 110, a single BPF 112, and single ADC 114, the polarization radar architecture 100 may include multiples of each or any combination of these components, and may be configured to perform, analogous functionality to that described above. For example, the polarization radar architecture 100 can include necessary components for angle of arrival estimation (e.g., multiple-input and multiple-output (MIMO) radar). It should be further appreciated that various components can be added to the polarization radar architecture 100 or replace components of the architecture. For example, the polarization radar architecture 100 can include a low noise amplifier (LNA), which can be an integrated circuit for amplifying a signal. The LNA can be incorporated into the architecture configured to minimize the introduction of additional noise while amplifying the signal. For example, the LNA can be incorporated into the architecture downstream from the receiver antenna 108 to boost the received signal. In addition, the polarization radar architecture 100 can include a quadrature mixer to reduce system noise and interference susceptibility.

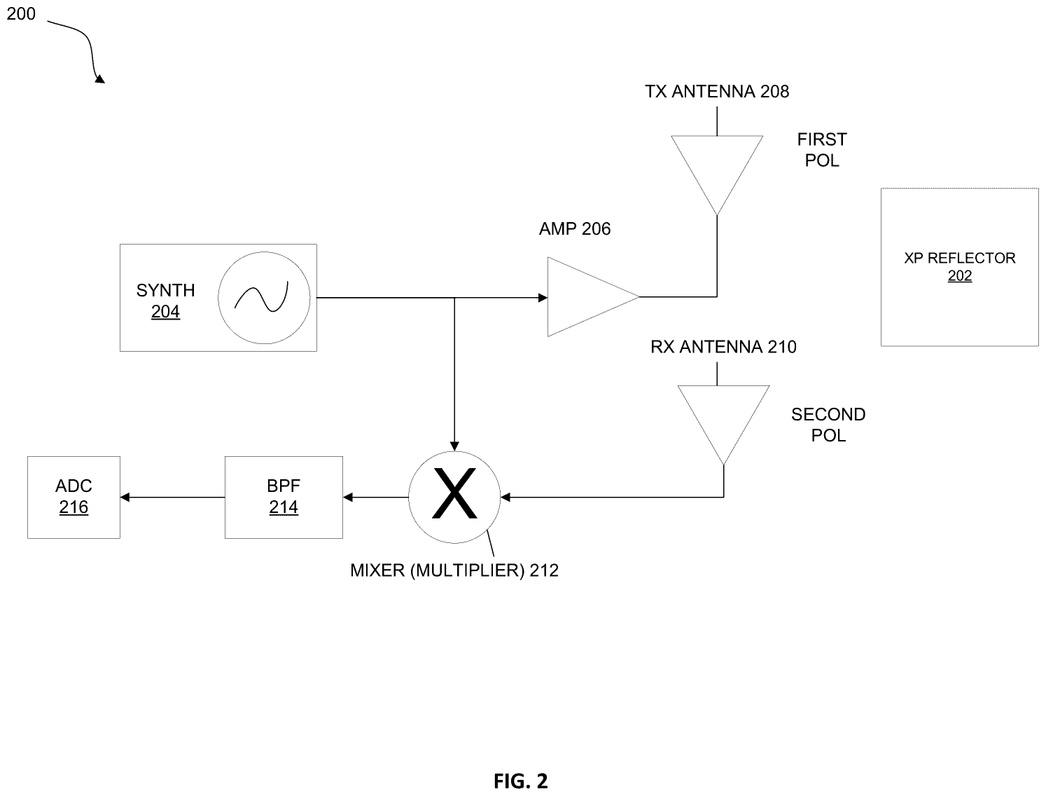

FIG. 2 is an illustration of a cross-polarization radar architecture 200 and reflector, according to one or more embodiments. The cross-polarization radar architecture 200 can be a similar or same architecture as described with respect to FIG. 1. In this instance, the cross-polarization radar architecture 200 can be co-designed with a cross-polarization (Xp) reflector 202 for improved detection performance. The cross-polarization radar architecture 200 and the Xp reflector 202 can be co-designed to improve various performance metrics, such as object detection and classification accuracy. The Xp reflector 202 can include materials to cause the transmitted signal having a first polarization to reflect a signal having a second polarization (e.g., such that the second polarization is orthogonal to the first polarization). The Xp reflector 202 can be made from some material that when impacted by a signal, causes the signal polarization to shift from the original polarization. For example, cross-polarization radar architecture 200 can include a radar transceiver with a vertical polarization (v-pol) transmit and horizontal polarization (h-pol) receive and the Xp reflector 202 can be designed to convert a signal from vertical polarization to horizontal polarization. Therefore, if the Xp reflector 202 is impacted with a signal having dominant vertical polarization, the reflected signal will have a dominant horizontal polarization.

The coupling of the cross-polarization radar architecture 200 and the Xp reflector 202 can be advantageous for object detection and classification. In a cluttered environment, if non-target objects largely reflect a co-polarized signal (e.g., same polarization as transmitted signal polarization), then the Xp reflector can provide benefits to signal-to-scatter (e.g., Xp reflector polarization power to non-target object power ratio) power ratio to improve detection and/or reduce of radar-cross section (size) of Xp necessary for desired detection performance.

The coupling of the cross-polarization radar architecture 200 and the Xp reflector 202 can be implemented in various applications. For example, the Xp reflector 202 can be incorporated into clothing either as a material that can be part of the clothing or tag affixed to the clothing. In some embodiments, multiple articles of clothing can include a respective Xp reflector 202, where each Xp reflector 202 can be configured to induce a different reflected signal having a unique set of characteristics based on a common stimulus signal. In this sense, a single device can discern different objects in a single environment based on transmitting a common stimulus signal and detecting varying reflected signal characteristics induced by each Xp reflector 202. In another example, the Xp reflector 202 can be incorporated into an object, such as framed artwork, a statute, or a door. In this example, the Xp reflector 202 can be incorporated in various ways, such as paint, a sticker, or a tag. A device can transmit a signal having a first polarization (stimulus signal) at the object and receive a signal having a second polarization. The device can detect and classify the object based on a known response associated with the object to the stimulus signal.

The cross-polarization radar architecture 200 can include a synthesizer 204 for generating a signal in the millimeter range. The signal can be transmitted across a transmission line and received by an amplifier 206. The amplifier 206 can transmit a signal to a transmitter antenna 208. The transmitter antenna 208 can be configured to receive the signal and transmit polarized millimeter waves in the direction of an environment that includes the Xp reflector 202.

The polarization of the transmitted signal can be configured to be orthogonal to the polarization of a reflected signal that is to be received by the cross-polarization radar architecture 200. For example, consider an instance in which the Xp reflector 202 can be configured to be impacted by a signal having a vertical polarization and reflect back a signal having a horizontal polarization. The transmitter antenna 208 can be configured to transmit a signal having a vertical polarization, and a receiver antenna 210 can be configured to receive the reflected signal from the Xp reflector 202, the signal having a horizontal polarization.

The receiver antenna 210 can be configured to receive a signal having a target polarization (e.g., vertical, horizontal, circular, elliptical, slanted) that can be orthogonal to the polarization of the signal transmitted by the transmitter antenna 208. The signal received by the receiver antenna 210 can include characteristics (e.g., phase, magnitude, reflectance, angle, polarization state) to be used to classify an object in an environment, including the object with the Xp reflector 202. The mixer 212 can transmit the signal to a BPF 214, which can transmit the signal to an ADC 216. The ADC 216 can convert the analog signal received from the BPF 112 into a digital signal. The ADC 216 can transmit the digital signal to a one or more processing units for object detection and classification.

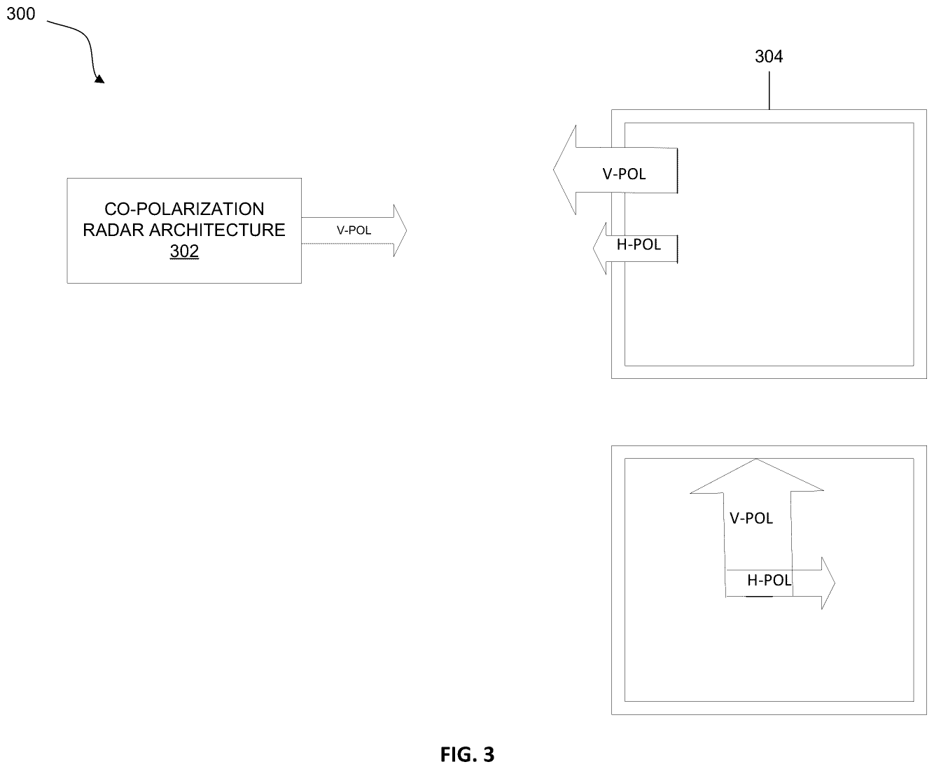

FIG. 3 is an example illustration 300 of a co-polarization radar architecture and target object, according to one or more embodiments. Consider an instance in which a co-polarization radar architecture 302 can be tasked with detecting and classifying a target object 304, which can be any tangible object in an environment. The co-polarization radar architecture 302 can include a transmitter and receiver that are each configured to have the same first polarization (e.g., vertical polarization). As illustrated, the target object 304 can be a framed artwork, such as a picture or a painting in a home or gallery. Furthermore, the material properties for the target object 304 can be such that that object can reflect a signal that has co-polarization components with greater signal strength (e.g., polarization that matches the polarization of the signal transmitted by the co-polarization radar architecture 302) than the cross-polarization component's signal strength. As illustrated, the vertically polarized signal can have a greater signal strength than the horizontally polarized signal. For illustrative purposes, a phasor representation of the signal reflected from the target object are also provided. As described above, a receiver antenna of the co-polarization radar architecture 302 can be configured to receive a reflected signal that has a polarization that can be orthogonal to the polarization of the signal transmitted by the co-polarization radar architecture 302. As further described above, the vertically polarized signal can have a greater signal strength than the horizontally polarized signal. Therefore, it can be advantageous for cross-polarization techniques described herein for the target object 304 to include a reflector, such that a signal reflected off the reflector has a different polarization than the signal reflected off of the target object 304. By introducing a reflector to the target object, the embodiments described herein can modify the reflection characteristics of the target object 304. By modifying the reflection characteristics, the embodiments described here can improve the detection of the target object 304. For example, the radar cross section (RCS) associated with an object can be polarization dependent. Therefore, by either modifying an object to include a reflector material or to affix an external reflector to the object, the RCS associated with an object can be modified.

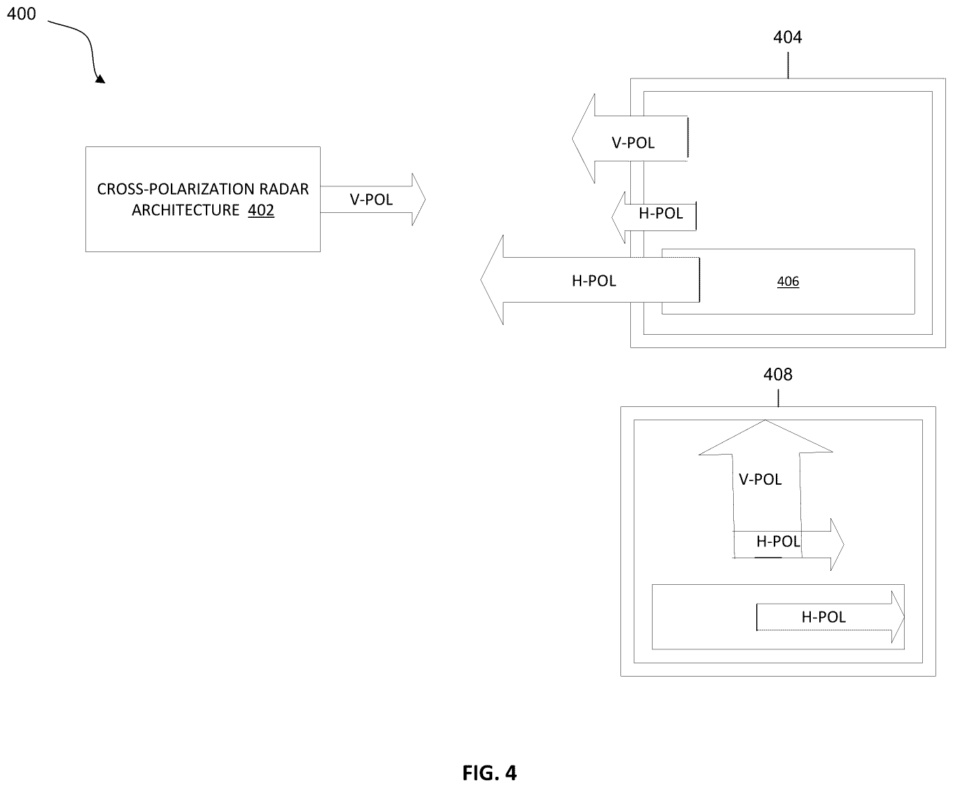

FIG. 4 is an example illustration 400 of a cross-polarization radar architecture 402, clutter object 404, and an Xp reflector 406 (where the Xp reflector 406 is the target object), according to one or more embodiments. The cross-polarization radar architecture 402 can be the same architecture as the cross-polarization radar architecture 200 of FIG. 2. The clutter object 404 has material properties such that the reflected signal has larger co-polarization components than cross-polarization components. However, as seen, the signal transmitted from the cross-polarization radar architecture 402 also impacts the Xp reflector 406. This enables the Xp reflector 406 to reflect a strong signal that has polarization different (e.g., orthogonal) from the signal transmitted by the cross-polarization radar architecture 402. The cross-polarized signal reflected from the Xp reflector 406 has a greater signal strength than the co-polarized signal that naturally reflects from the clutter object 404. The signal strength of the signal reflected off the Xp reflector 406 improves the signal quality of the received signal and increases the accuracy of the object detection and classification performed by the cross-polarization radar architecture 402. For illustrative purposes, a phasor representation 408 of the signal reflected from the clutter object 404 and the Xp reflector 406 are also provided.

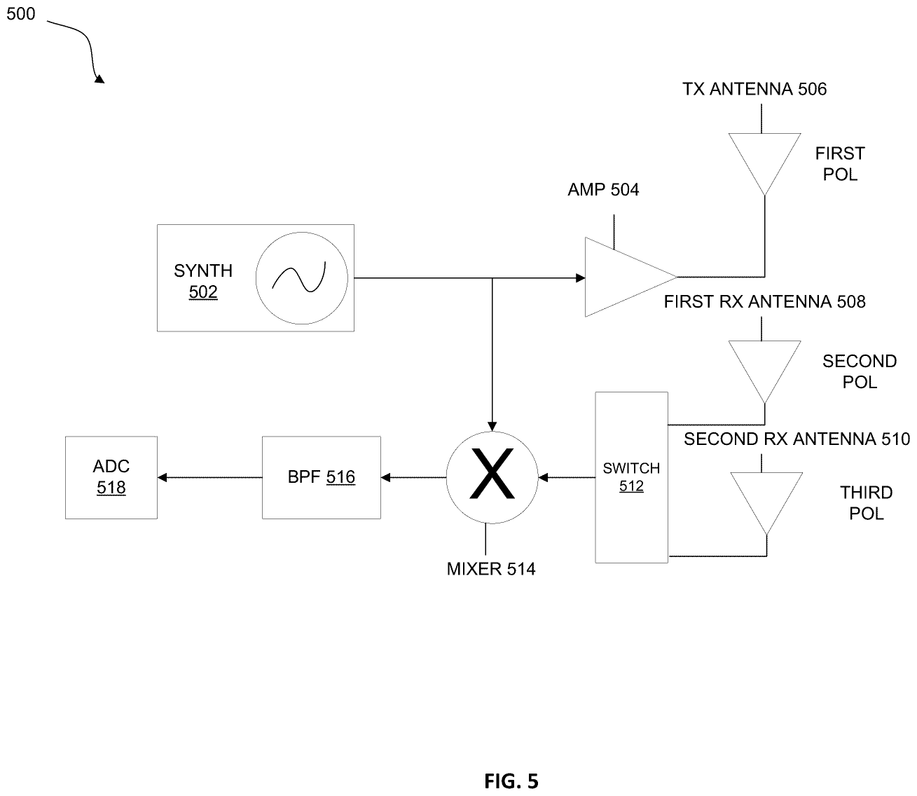

FIG. 5 is an illustration of a dual-polarization radar architecture with a switch 500, according to one or more embodiments. The dual-polarization radar architecture with a switch 500 includes a synthesizer 502 for generating an electrical waveform suitable for wireless sensing. The generated signal can be transmitted across a transmission line and received by an amplifier 504. The amplifier 504 (e.g., power amplifier) can amplify the signal and transmit the signal to a transmitter antenna 506. It should be appreciated for a person having ordinary skill in the art, that the illustrated transmitter chains and receiver chains in FIGS. 1, 2, and 5-9 can include additional elements, such as filters, mixers, amplifiers, and that the elements are not illustrated for the sake of brevity. It should further be appreciated that one or more elements can be removed. For example, the dual-polarization radar architecture illustrated in FIG. 5 can be switchless.

The transmitter antenna 506 can be configured to receive the amplified signal and transmit a polarized signal, for example, a vertically polarized signal. It should be appreciated that the radar architecture antennae are not limited to vertical polarization or horizontal polarization. The transmitter antenna 506 can be configured to transmit a signal having any specified polarization.

A first receiver antenna 508 and a second receiver antenna 510 can be configured to respectably receive a signal. The first receiver antenna 508 can be configured to receive a signal having a same polarization as the polarization of the signal transmitted by the transmitter antenna 506. The second receiver antenna 510 can be configured to receive a signal having a different polarization than the signal transmitted by the transmitter antenna 506. Each of the first receiver antenna 508 and the second receiver antenna 510 can be connected to a switch 512, which contains switching hardware as well as software for governing signal flow. Structurally, the switch 512 can be arranged proximate to the first receiver antenna 508 and the second receiver antenna 510 to conserve layout space. In some embodiments, rather than the switch 512, the dual-polarization radar architecture with a switch 500 can implement two full receiver chains. In another embodiment, the dual-polarization radar architecture with a switch 500 can implement a mode switching to switch from horizontal polarization to vertical polarization or from vertical polarization to horizontal polarization. The dual-polarization radar architecture with a switch 500 can switch between modes on chirp to chirp, frame to frame, or mode to mode.

Based on the state of the switch 512, the first receiver antenna 508 or the second receiver antenna 510 can transmit the received signal to a mixer 514. The mixer 514 can transmit the signal to a BPF 516. The BPF 516 can transmit the filtered signal to an ADC 518. The ADC 518 can transmit the digital signal to one or more processing units to detect and classify the target object.

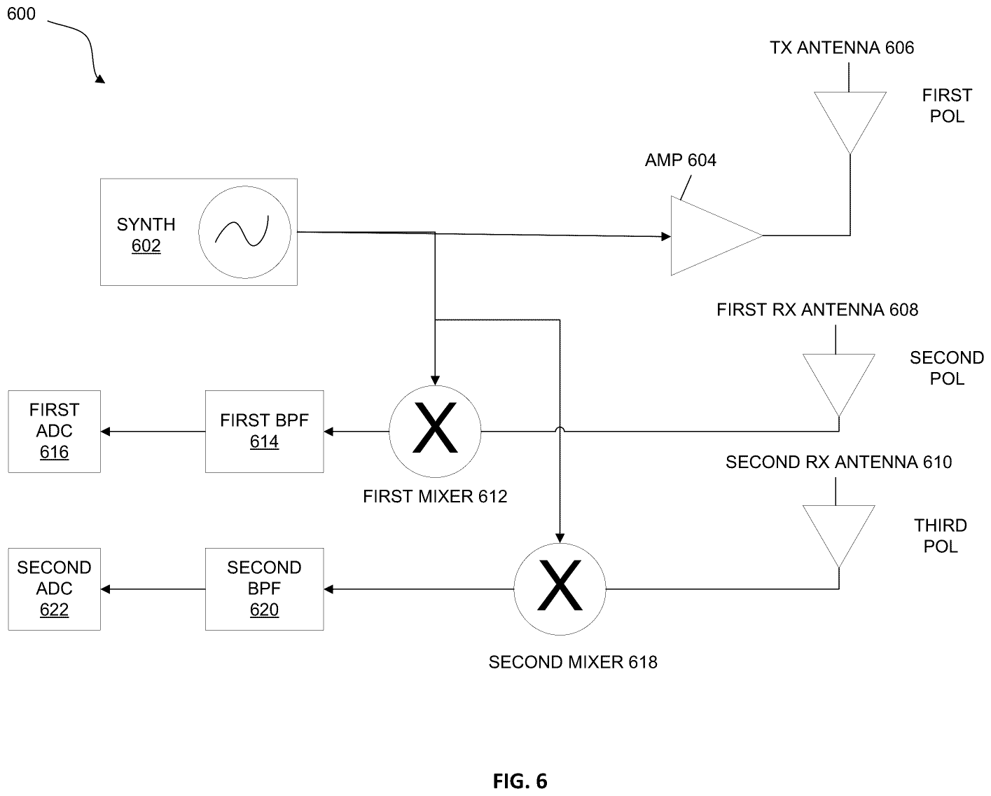

FIG. 6 is an illustration of a switchless dual-polarization receive radar architecture 600, according to one or more embodiments. An advantage of this architecture can be that there is no requirement for switching between first and second polarizations, and, for example, simultaneous processing of signals from both the first polarization and the second polarization can be accomplished. Furthermore, joint process of received polarizations can be implemented to perform polarization-exploiting beam forming, further enabling object and material classification. The switchless dual-polarization radar architecture 600 includes a synthesizer 602 for generating an electrical waveform over a wide range of signals. The generated signal can be transmitted across a transmission line and received by an amplifier 604 for amplification. The amplified signal can be transmitted from the amplifier 604 to a transmitter antenna 606. The transmitter antenna 606 can be configured to receive the amplified signal and transmit a polarized signal.

A first receiver antenna 608 and a second receiver antenna 610 can be configured to respectably receive a signal. The first receiver antenna 608 can be configured to receive a signal having a co-polarization with the polarization of the signal transmitted by the transmitter antenna 606. For example, the first receiver antenna 608 can be configured to receive a signal having a vertical polarization. The second receiver antenna 610 can be configured to receive a signal having a cross-polarization with the polarization of the signal transmitted by the transmitter antenna 606. For example, the first receiver antenna 608 can be configured to receive a signal having a vertical polarization and the second receiver antenna 610 can be configured to receive a signal having a horizontal polarization.

The first receiver antenna 608 can transmit the received signal to a first mixer 612. The first mixer 612 can transmit the signal to a first BPF 614. The first BPF 614 can transmit the filtered signal to a first ADC 616. The first ADC 616 can convert the analog signal received from the first BPF 614 into a digital signal. The first ADC 616 can transmit the digital signal to one or more processing units to detect and classify the target object.

The second receiver antenna 610 can transmit the received signal to a second mixer 618. The second mixer 618 can transmit the signal to a second BPF 620. The second BPF 620 can transmit the filtered signal to a second ADC 622. The second ADC 622 can convert the analog signal received from the second BPF 620 into a digital signal. The second ADC 622 can transmit the digital signal to one or more processing units to detect and classify the target object. The one or more processing units can be the same one or more processing units that received a digital signal from the first ADC 616. In this sense, the one or more processing units can detect and analyze signal characteristics from a signal with a first polarization and a signal with a second polarization.

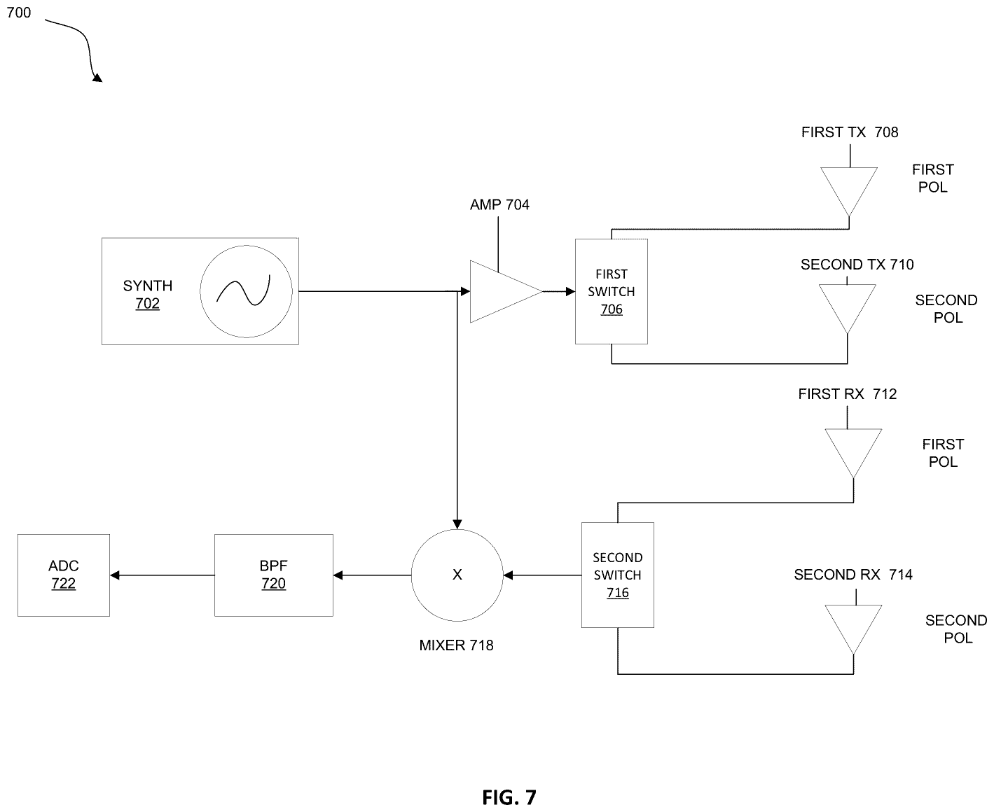

FIG. 7 is an illustration of a dual-polarization transmit and receive radar architecture 700, according to one or more embodiments. As illustrated, the dual-polarization transmit and receive radar architecture 700 can include two transmitter chains and two receiver chains that enable exploitation of differences in the reflection characteristics under excitation from a stimulus signal. The architecture can enable two polarizations on the transmission side and two polarizations on the receiver side to tune a transmitted signal and/or a received signal with respect to a target object. A signal transmitted and received can be selected (e.g., the two polarizations, or other appropriate characteristic(s)) based on target characteristics.

The dual-polarization transmit and receive radar architecture 700 includes a synthesizer 702 for generating an electrical waveform over a wide range of signals. The synthesizer 702 can transmit the signal to an amplifier 704, which can transmit the signal to a first switch 706. The first switch 706 can transmit a signal to a first transmitter antenna 708 configured for a first polarization (e.g., vertical polarization) or a second transmitter antenna 710 configured for a second polarization (e.g., horizontal polarization). The dual-polarization transmit and receive radar architecture 700 can further use the amplitude and phase relationships between the vertical and horizontal ports to configure the polarizations of the transmitters and receivers.

A first receiver antenna 712 can be configured to receive a signal have a first polarization (e.g., vertical polarization). A second receiver antenna 714 can be configured to receive a signal have a second polarization (e.g., horizontal polarization). The first receiver antenna 712 and/or the second receiver antenna can transmit a received signal to a second switch 716. The second switch can be configured to allow a signal from either the first receiver antenna 712 or the second receiver antenna 714 to pass through to a mixer 718. The first switch 706 and the second switch 716 can be configured to allow four different combinations of transmit and receive polarizations (e.g., first transmitter antenna 708 and first receiver antenna 712, second transmitter antenna 710 and first receiver antenna 712, first transmitter antenna 708 and second receiver antenna 714, second transmitter antenna 710 and second receiver antenna 714). The mixer 718 can transmit the signal to a BPF 720. The BPF 720 can transmit the filtered signal to an ADC 722. The ADC 722 can convert the analog signal received from the BPF 720 into a digital signal. The ADC 722 can transmit the digital signal to one or more processing units to detect and classify the target object.

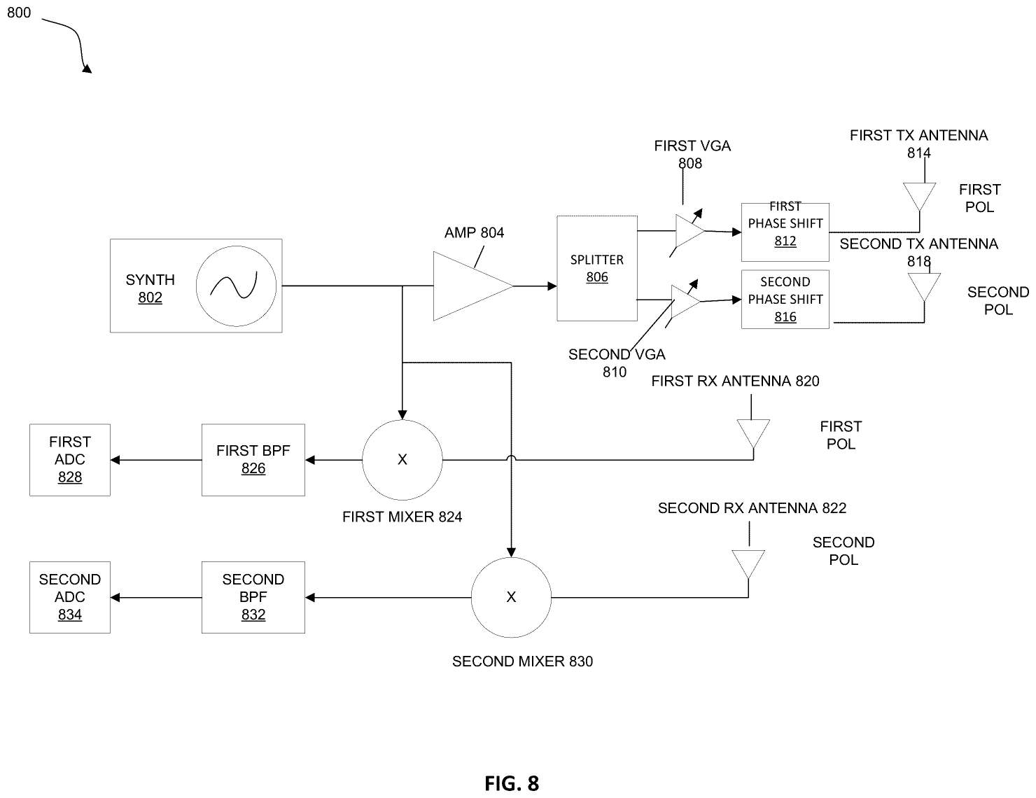

FIG. 8 is an illustration of a polarization-exploiting transmit and receive radar architecture 800, according to one or more embodiments. As illustrated, the polarization-exploiting transmit and receive radar architecture 800 can include two transmitter chains and two receiver chains that enable multiple polarizations for the exploitation of differences in the reflection characteristics under excitation from a stimulus signal using multiple polarizations simultaneously or switching between antenna ports. The architecture can enable multiple polarizations on the transmission side and multiple polarizations on the receiver side to tune a transmitted signal and/or a received signal with respect to a target object. For example, the transmitted and received signals can be tuned based on various characteristics of the target object (and/or reflector), such as material, surface, shape, orientation, distance, and other relevant characteristics that enable improved object detection and characterization. Therefore, a signal transmitted and received can be controlled (e.g., multiple polarizations, or other appropriate characteristic(s)) based on target characteristics. This concept of tailoring signals for improved object detection and characterization can also be applied to architectures that include switches and polarization mode controllers.

For another example, the polarization-exploiting transmit and receive radar architecture 800 can enable a millimeter wave version of spectroscopy by leveraging dichroism principles. In particular, circular dichroism (CD), which involves the differential absorption of left- and right-handed light. The polarization-exploiting transmit and receive radar architecture 800 coupled with one or more Xp reflectors can enable polarization-based discrimination of a larger number of different objects in a radar scene. For example, an Xp reflector can be configured to convert vertical polarization into RHCP, and another Xp reflector can be configured to convert a vertical polarization to a LHCP. This could be extended to elliptical polarizations, as well, expanding the potential set of different objects that can be discriminated. This level of configurability increases the possible permutations of a transmitted signal and received reflected signal. Each of the permutations can exhibit different signal characteristics to enhance the object detection and classification functionality of the polarization-exploiting transmit and receive radar architecture 800. It should be appreciated that FIG. 8 is illustrated with respect to a single transmission port and receiver port. In other embodiments, additional ports can be included for a desired number of transmitter ports and receiver ports, and a multiple input multiple output (MIMO) configuration. It should further be appreciated that for illustrations purposes, FIG. 8 does not include a low noise amplifier (LNA), if any, or a complex mixer dual ADCs, if any.

The polarization-exploiting transmit and receive radar architecture 800 includes a synthesizer 802 for generating an electrical waveform over a wide range of signals. The synthesizer 802 can transmit the signal to an amp 804, which can transmit the signal to a first splitter 806. The splitter 806 can be a passive device for receiving an input signal and transmitting multiple output signals, each with desired amplitude and phase characteristics. The splitter 806 can transmit a first signal to a first variable gain amplifier (VGA) 808 and a second signal to a second VGA 810. Each VGA can be an amplifier that can vary a gain based on a control voltage. The first VGA 808 can transmit a signal to a first phase shift 812 configured to shift a phase of the received signal. The first phase shift 812 can transmit an output to a first transmitter antenna 814. The second VGA 810 can transmit a signal to a second phase shift 816 configured to shift a phase of the received signal. The first phase shift 812 can transmit an output to a second transmitter antenna 818.

The transmitter side components can be used to control the amplitude and phase and tow polarizations, which can enable the creation of a variety of polarizations. For example, the creation of a linear polarization with any angle, circular polarization, right hand and left hand circular polarization, and right and left hand elliptical polarization. The different polarizations can be used for excitation of the environment and targets with exploitations of polarization sensitivity differences. In some embodiments, an implementation can include a patch antenna with two feeds, one configured for vertical polarization and the other configured for horizontal polarization.

A first receiver antenna 820 can be configured to receive a signal have a first polarization (e.g., vertical polarization). A second receiver antenna 822 can be configured to receive a signal have a second polarization (e.g., horizontal polarization). The first receiver antenna 820 can transmit a received signal to a first mixer 824. The first mixer 824 can transmit the signal to a first BPF 826. The first BPF 826 can transmit the filtered signal to a first ADC 828. The first ADC 828 can transmit the digital signal to one or more processing units to detect and classify the target object. The second receiver antenna 822 can transmit a received signal to a second mixer 830. The second mixer 830 can transmit the signal to a second BPF 832. The second BPF 832 can transmit the filtered signal to a second ADC 834. The second ADC 834 can transmit the digital signal to one or more processing units to detect and classify the target object.

The receiver side signals can be processed to enable beam forming with polarization exploitation and enhanced detection and discrimination of targets according to polarization dependent reflection characteristics.

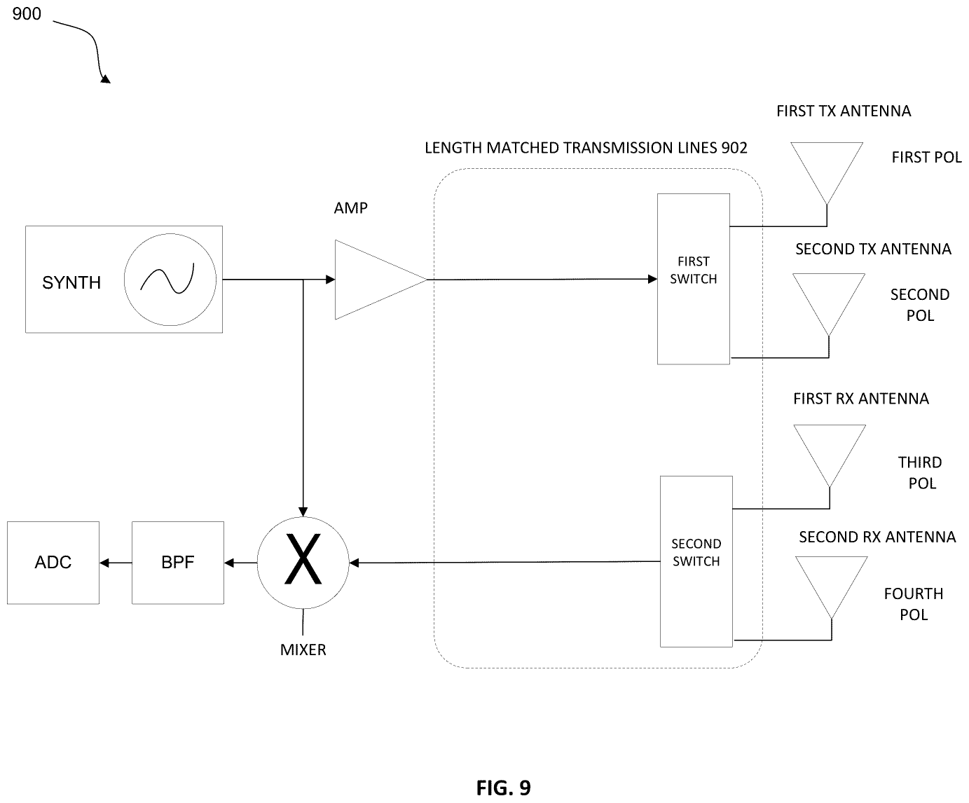

FIG. 9 is an illustration of a dual-polarization transmit and receive radar architecture with a switch 900, according to one or more embodiments. The elements of this architecture can generally be the same as the elements of the dual-polarization transmit and receive radar architecture having matched transmission lines 902 to provide delay matching while also reducing the layout space requirement for the transmission lines.

The dual-polarization transmit and receive radar architecture with a switch 900 can include transmission lines 902 to configure the time and distance of the transmission signals and the reception signals. The length of the lines can be configured to match the signal delay of a signal transmitted to the transmitter antenna with the signal delay transmitter of a signal transmitted from the receiver antenna.

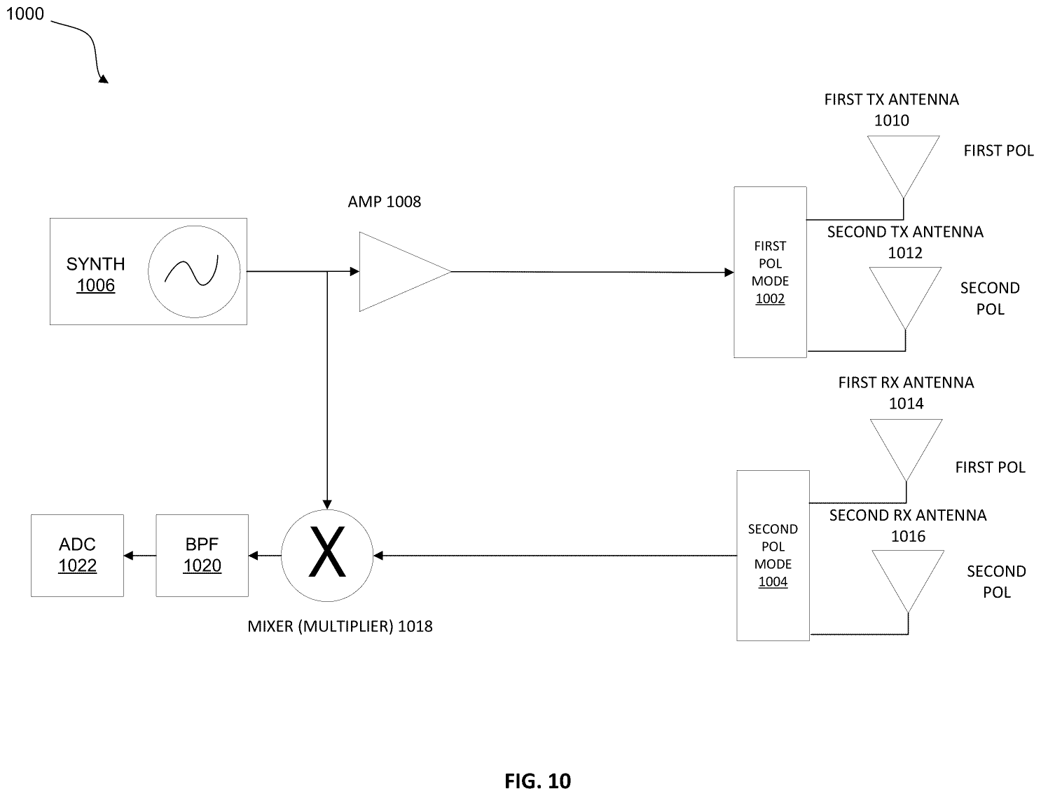

FIG. 10 is an illustration of a dual-polarization transmit and receive radar architecture with mode switching 1000, according to one or more embodiments. The elements of this architecture can generally be the same as the elements of the dual-polarization transmit and receive radar architecture having a first polarization mode controller (first pol mode) 1002 and a second polarization mode controller (second pol mode) 1004, which can be controlled by software for achieving a desired mode.

The dual-polarization transmit and receive radar architecture with mode switching 1000 includes a synthesizer 1006 that can transmit a signal to an amp 1008. The amp 1008 can transmit a signal to the first pol mode 1002. The first pol mode 1002 can receive control instructions and select a polarization mode (e.g., linear, circular, elliptical, slanted) based on the instructions. The signal can be transmitted from the first pol mode 1002 to the first transmitter antenna 1010, the second transmitter antenna 1012, or a combination of both antennas. The selected first transmitter antenna 1010 and/or the second transmitter antenna 1012 can transmit the signal having the selected polarization mode. In some instances, the first transmitter antenna 1010 or the second transmitter antenna 1012 can be configured to transmit signals having polarities that are orthogonal to each other. For example, the first transmitter antenna 1010 can be configured to transmit a signal having a vertical polarization and the second transmitter antenna 1012 can be configured to transmit a signal having a horizontal configuration. In this case, the first pol mode controls the amplitude and phase of the signal on each TX antenna to implement the desired radiated signal polarization.

A first receiver antenna 1014 and a second receiver antenna 1016 can be configured to receive a signal reflected from a target object (e.g., Xp reflector). Each of the first receiver antenna 1014 and the second receiver antenna 1016 can be connected to a second pol mode 1004. The second pol mode's selection of polarization mode can be independent of the first pol mode 1002, as the second pol mode 1004 has to receive a signal that has a polarization that is dependent on the target characteristics and stimulus polarization. Of course, in one implementation the first pol mode 1002 has selected a vertical polarization, the second pol mode has a horizontal polarization. Similar to the transmitter antennae and the first pol mode 1002, the first receiver antenna 1014 and the second receiver antenna 1016 can be configured to receive signals having a variety of amplitudes and phases of the signals from each receiver antenna.

The second pol mode 1004 can pass a signal from the first receiver antenna 1014, the second receiver antenna 1016, or a combination thereof to a mixer 1018. The mixer 1018 can transmit the signal to a BPF 1020. The BPF 1020 can transmit the filtered signal to an ADC 1022. The ADC 1022 can convert the analog signal received from the BPF 1020 into a digital signal. The ADC 1022 can transmit the digital signal to one or more processing units to detect and classify the target object.

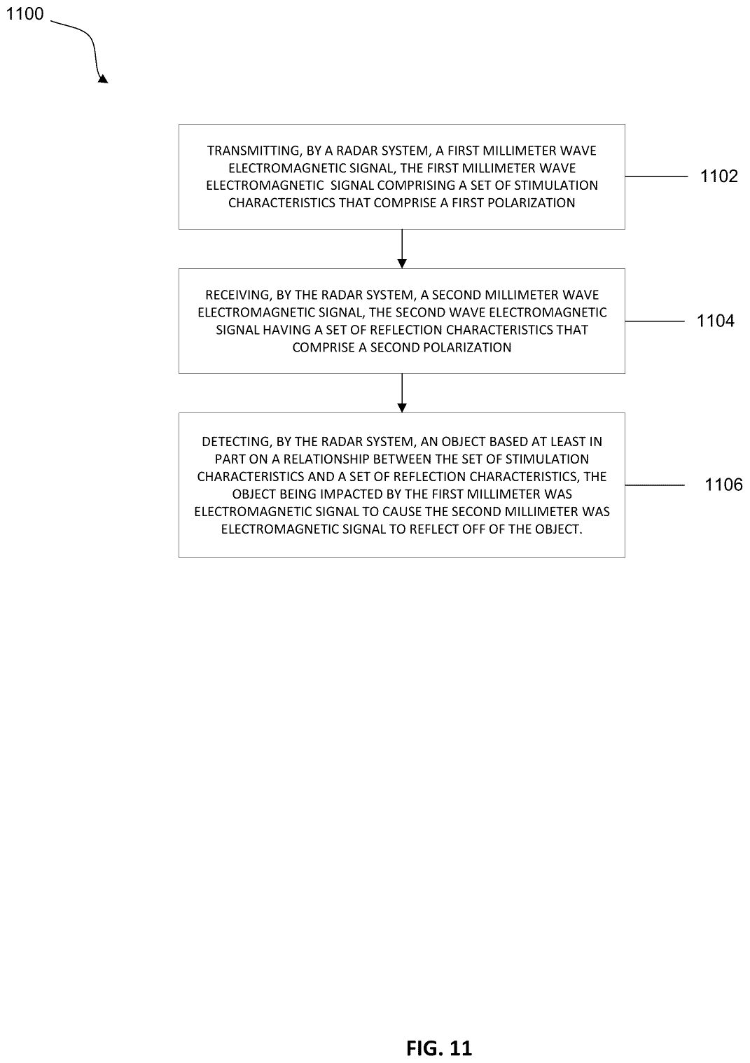

FIG. 11 is a process flow 1100 for object detection via cross-polarization, according to one or more embodiments. While some operations of process 1100 are described as being performed by generic computers, it should be understood that any suitable device may be used to perform one or more operations of these processes. Process 1100 is respectively illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 1102, the method can include a radar system transmitting, via a first transmitter antenna, transmit a first millimeter wave electromagnetic signal, where the signal includes a set of stimulation characteristics that include a first polarization. The first transmitter antenna can perform the transmission in response to receiving control instructions from a device controller. The radar system controller can act upon an input to initiate a remote sensing session to detect and classify objects, including a target object. The radar system controller can implement a polarization exploitation technique to detect and classify objects. The control instructions can further include instructions to configure the first millimeter wave electromagnetic signal to have a set of signal characteristics, including a first polarization. The signal characteristics can be based on the properties of a target object or a target environment. The properties can include material properties, reflective properties, or other appropriate properties.

The first polarization can be a polarization state of the first millimeter wave electromagnetic signal (e.g., vertical, horizontal, circular, slanted, elliptical). The second polarization can also be polarization state of the signal to be transmitted by the second transmitter antenna, where the second polarization can be different than the first polarization. For example, if the first polarization is a vertical polarization, the second polarization can be a horizontal polarization.

At 1104, the method can include the radar system receiving, via a first receiver antenna a second millimeter wave electromagnetic signal, where the signal has a second polarization that can be different than the first polarization. For example, if the first polarization is a LHCP, the second polarization can be a RHCP. The second millimeter wave electromagnetic signal can be a signal that has reflected off of an object in an environment. The object can be a stationary object or a moving object. The second millimeter wave electromagnetic signal can further include signal characteristics that can enable the determination of a distance, relative position, and composition of the object.

In some embodiments, the object can be an Xp reflector, which can enhance the polarization component of an object. For example, the Xp reflector can be integrated with the object, such as an object component that can be specifically designed to have certain reflective characteristics. The Xp reflector can also be attached to the object. For example, the object can be a person or a car that has an Xp reflector sticker or Xp reflector tag attached. Therefore, in instances that the object may not induce a strong polarization component of a reflected wave, the Xp reflector can provide the material composition, design and/or surface profile to reflect a signal with a strong polarization component.

At 1106, the method can include the radar system detecting an object based at least in part on the second millimeter wave electromagnetic signal, where the object can be impacted by the first millimeter wave electromagnetic signal and cause the second millimeter wave electromagnetic signal to be reflected off of the object. The radar system can detect the object, including detecting a distance, a relative position, and a material composition of the object. In some instances, the object is a target object, and in other instances, the object can be an object that is in a surrounding environment of the target object. In either case, the radar system can use the signal characteristics to distinguish the target object from the environment.

The second millimeter wave electromagnetic signal can include characteristics (e.g., phase, magnitude, reflectance, dominant polarization angle, polarization state) that can be used to detect and classify the object. For example, the radar system can determine the time elapsed between the transmission of the first millimeter wave electromagnetic signal and reception of the second millimeter wave electromagnetic signal to determine a distance of the object from the radar architecture.

In some instances, the radar system includes multiple antennae, and the processing circuitry can determine a relative position of the object based on a time of flight (ToF) calculation for signals emitted and received at each antenna. The processing circuitry can further use the characteristics of the second millimeter wave electromagnetic signal to determine the material composition of the object. For example, the radar system can compare a set of characteristics of a reflected signal to a table of reflected characteristics. Based on the comparison, the radar system can determine the material composition of the object.

As indicated above, in some instances, the object is an Xp reflector. In these instances, the Xp reflector can be configured to cause a reflected signal having characteristics that identify an underlying object associated with the Xp reflector. In some instances, multiple Xp reflectors can be configured respectively to be associated with different objects. The signal characteristics of a signal reflected off these reflectors can be used to identify the underlying objects.

For one or more embodiments, at least one of the components set forth in one or more of the preceding figures may be configured to perform one or more operations, techniques, processes, or methods as set forth in the example section below.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques, including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate, and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A system, comprising:
a first transmitter antenna configured for radiating a first millimeter wave electromagnetic signal, the first millimeter wave electromagnetic signal comprising a set of stimulations characteristics, the set of stimulation characteristics comprising a first polarization,
a first receiver antenna configured for receiving a second millimeter wave electromagnetic signal, the second millimeter wave electromagnetic signal comprising a set of reflection characteristics, the set of reflection characteristics comprising a second polarization; and
a processing circuitry configured to detect an object based at least in part on a relationship between the set of stimulation characteristics and the set of reflection characteristics, the object being impacted by the first millimeter wave electromagnetic signal to cause the second millimeter wave electromagnetic signal to reflect off the object.

2. The system of claim 1, wherein the processing circuitry is further configured to generate control instructions for a synthesizer to generate a signal that, when received by the first transmitter antenna, induces the first transmitter antenna to radiate the first millimeter wave electromagnetic signal having the first polarization.

3. The system of claim 1, wherein the system further comprises:
a second receiver antenna configured for receiving a third millimeter wave electromagnetic signal, the third millimeter wave electromagnetic signal comprising the first polarization; and
a first switch for selecting between the first receiver antenna or the second receiver antenna.

4. The system of claim 3, wherein the system further comprises:
a second transmitter antenna configured for radiating a fourth millimeter wave electromagnetic signal, the fourth millimeter wave electromagnetic signal comprising the second polarization; and
a second switch for selecting between the first transmitter antenna and the second transmitter antenna.

5. The system of claim 1, wherein the system further comprises a second receiver antenna configured for receiving a third millimeter wave electromagnetic signal, the third millimeter wave electromagnetic signal comprising the first polarization, wherein the first receiver antenna is configured to transmit the second millimeter wave electromagnetic signal to a first mixer, and wherein the second receiver antenna is configured to transmit the third millimeter wave electromagnetic signal to a second mixer.

6. The system of claim 1, wherein the system comprises transmission lines with matching lengths configured for delay matching.

7. The system of claim 1, wherein the object comprises a reflector configured to be impacted by the first millimeter wave electromagnetic signal comprising the first polarization and reflecting the second millimeter wave electromagnetic signal comprising the second polarization.

8. A method, comprising:
transmitting, by a radar system, a first millimeter wave electromagnetic signal, the first millimeter wave electromagnetic signal comprising a set of stimulations characteristics, the set of stimulation characteristics comprising a first polarization;
receiving, by the radar system, a second millimeter wave electromagnetic signal, the second millimeter wave electromagnetic signal comprising a set of reflection characteristics, the set of reflection characteristics comprising a second polarization; and
detecting, by the radar system, an object based at least in part on a relationship between the set of stimulation characteristics and the set of reflection characteristics, the object being impacted by the first millimeter wave electromagnetic signal to cause the second millimeter wave electromagnetic signal to reflect off the object.

9. The method of claim 8, wherein the method further comprises generating control instructions for a synthesizer to generate a signal that, when received by a first transmitter antenna of the radar system, induces the first transmitter antenna to radiate the first millimeter wave electromagnetic signal having the first polarization.

10. The method of claim 8, wherein the method further comprises selecting between a first receiver antenna and a second receiver antenna based at least in part on a desired polarization, wherein the second receiver antenna is configured for receiving a third millimeter wave electromagnetic signal, the third millimeter wave electromagnetic signal comprising the first polarization.

11. The method of claim 8, wherein the method further comprises selecting between a first transmitter antenna and a second transmitter antenna based at least in part on a desired polarization, wherein the second transmitter antenna is configured for radiating a fourth millimeter wave electromagnetic signal, the fourth millimeter wave electromagnetic signal comprising the first polarization.

12. The method of claim 8, wherein the first polarization comprises a vertical polarization and the second polarization comprises a horizontal polarization.

13. The method of claim 8, wherein the method further comprises matching a first length of a transmission line to a first transmitter antenna to a second length of a transmission line from a first receiver antenna for delay matching.

14. The method of claim 8, wherein the object comprises a reflector configured to be impacted by the first millimeter wave electromagnetic signal comprising the first polarization and reflecting the second millimeter wave electromagnetic signal comprising the second polarization.

15. A non-transitory computer-readable medium including stored thereon a sequence of instructions that, when executed by a processor of a cloud infrastructure node, causes the processor to perform operations comprising:
transmitting a first millimeter wave electromagnetic signal, the first millimeter wave electromagnetic signal comprising a set of stimulation characteristics, the set of stimulation characteristics comprising a first polarization;
receiving a second millimeter wave electromagnetic signal, the second millimeter wave electromagnetic signal comprising a set of reflection characteristics, the set of reflection characteristics comprising a second polarization; and
detecting an object based at least in part on a relationship between the set of stimulation characteristics and the set of reflection characteristics, the object being impacted by the first millimeter wave electromagnetic signal to cause the second millimeter wave electromagnetic signal to reflect off the object.

16. The non-transitory computer-readable medium of claim 15, wherein the operations further comprise generating control instructions for a synthesizer to generate a signal that, when received by a first transmitter antenna of a radar system, induces the first transmitter antenna to radiate the first millimeter wave electromagnetic signal having the first polarization.

17. The non-transitory computer-readable medium of claim 15, wherein the operations further comprise selecting between a first receiver antenna and a second receiver antenna based at least in part on a desired polarization, wherein the second receiver antenna is configured for receiving a third millimeter wave electromagnetic signal, the third millimeter wave electromagnetic signal comprising the first polarization.

18. The non-transitory computer-readable medium of claim 15, wherein the operations further comprise selecting between a first transmitter antenna and a second transmitter antenna based at least in part on a desired polarization, wherein the second transmitter antenna is configured for radiating a fourth millimeter wave electromagnetic signal, the fourth millimeter wave electromagnetic signal comprising the second polarization.

19. The non-transitory computer-readable medium of claim 15, wherein the first polarization comprises a vertical polarization and the second polarization comprises a horizontal polarization.

20. The non-transitory computer-readable medium of claim 15, wherein the object comprises a reflector configured to be impacted by the first millimeter wave electromagnetic signal comprising the first polarization and reflecting the second millimeter wave electromagnetic signal comprising the second polarization.
